(19) United States
(12) Patent Application Publication
(10) Pub. No.: US 2009/0104928 A1
(43) Pub. Date: Apr. 23, 2009

(54) PORTABLE ELECTRONIC DEVICE AND A METHOD FOR ENTERING DATA ON SUCH A DEVICE

(75) Inventors: Ulf Petter ALEXANDERSSON, Lund (SE); Werner Jonatan GRONKVIST, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/930,966

(22) Filed: Oct. 31, 2007

Related U.S. Application Data
(60) Provisional application No. 60/981,596, filed on Oct. 22, 2007.

(51) Int. Cl. H04Q 7/20

(52) U.S. Cl. 455/550.1

(57) ABSTRACT

The present invention relates to a portable electronic device comprising one or several touch-sensitive keypads used for entering data on such a device. The invention also relates to a method for entering data on such a portable electronic device. The touch sensitive keypad including a plurality of keys where at least one of the keys is overlaid with multiple input options, a display where the multiple input options is presented when one of the keys senses an object's presence on the key, wherein each input option is a symbol and each input option is associated with a specific level, which is detected by a specific level detection means.

### TECHNICAL FIELD

The present invention relates generally to user interfaces of portable electronic devices. More particularly, the invention relates to a portable electronic device comprising one or several touch-sensitive keypads used for entering data on such a device. Further, the invention relates to a method for entering data on such portable electronic device.

### BACKGROUND ART

The use of portable electronic devices with data input capabilities, such as computers and mobile phones, has had an enormous development in the world in the last decades.

Electronic devices such as mobile, portable or wireless telephones, personal digital assistants (PDA), handheld computers, and similar devices typically include a keyboard, keypad or similar means of data input. Such devices will be referred to herein as portable devices or mobile phones.

The portable device as a type of electronic communication device has evolved to be a personal necessity. People are on the move and they want their information to move with them. They are sending short text messages from one portable device to another.

Making information move fast is the premise behind Short Message Service (SMS), the transmission of text message to and from portable devices. Speed is one reason why text messaging has taken off so dramatically since the first messages were sent. Efficiency is another reason why more and more people use text messaging.

However, a keypad or keyboard for a portable device has to be small and slim and they are only equipped with a small number of buttons where symbols, such as characters, letters, digits, notes etc. are overlaid on a single button for option selection. For an example, alphanumeric characters/digits “1”, “a”, “b” and “c” share the same button. This is a phone standard for arrangement of alphanumeric characters/digits on the buttons of a keypad.

A commonly associated technique for data entry is called “Multi-tap single entry” or “multi-tap technique”, which make a user tap a character-shared button multiple times until a desired output is obtained out of those overlaid multiple input options of that button. It is thus not surprising that entering text in mobile phones using a traditional 4×3 keys keyboard has several weaknesses. This technique sacrifices or lowers the speed of data entry, as compared to the speed of data entry or input using a full-sized keyboard. This technique is also inefficient since the user has to quickly press several times.

Another disadvantage associated with the multi-tap technique is that it is ergonomically undesirable. Thumb typing lots of text messages on a tiny keyboard can put people at risk for musculoskeletal disorders (MSDs). Ergonomists warn about Text Message Injury, or TMI, which is the term currently used to describe injuries caused by text messaging. And because the injury develops over time, it is an MSD. What is well known is that typing with the thumb on a portable device involves three elements that can lead to MSDs, such as repetition, force and awkward position.

In summary, the existing Multi-tap technique is slow, inefficient and ergonomically questionable. A solution for more accurate, fast and ergonomically data entries using a small symbol shared keypad for a portable electronic communication device is thus desirable.

### SUMMARY OF THE INVENTION

With the above and following description in mind, then, an aspect of some embodiments of the present invention is to provide an improved input device, which seeks to mitigate, alleviate or eliminate one or more of the above-identified deficiencies in the art and disadvantages singly or in any combination.

An aspect of the present invention relates to a portable electronic device, comprising a touch sensitive keypad including a plurality of keys, at least one of the keys is overlaid with multiple input options, a display where the multiple input options is presented when one of the keys senses an object's presence on the key. The device further comprising that each input option is a symbol, each input option is associated with a specific level and the device further comprising means for detecting said specific level.

Each specific level may be entered stepwise in dependence of the input option. Further the specific level may be defined by a predetermined pressure applied on the key. The pressure may be applied downwards and/or sideways.

Each level may be defined by a predetermined time interval during which the object is present on the key.

The symbol may be a character, a letter or a digit.

The input option may be confirmed by releasing the contact on the key.

The keys may be overlaid by four input options, where each option is associated by a character, letter or digit.

Each input option may be presented by a specific sound and/or a tactile feedback.

Another aspect of the present invention relates to a method for entering inputs on a portable electronic device, comprising a keypad including a plurality of keys, where at least one of the keys is overlaid with multiple input options. The method comprising the steps of: associating each input option with a level and a symbol; presenting the multiple input options of the key when detecting an objects presence on the key and selecting an input option by changing levels.

The method may comprise the steps of entering each specific level stepwise in dependence of the input option. Each level may be defined by a predetermined pressure and the predetermined pressure may be applied on the key.

The method may further comprise the step of defining each level by a predetermined time limit and holding the object on the key the predetermined time limit.

The method may further comprise the steps of confirming the input option by releasing the contact on the key.

The method may further comprise the step of marking the selected input option. Each input option may be marked by a specific sound and/or a tactile feedback.

Some embodiments of the invention provide an improved device for data entry without using Multi-tap technique. It is an advantage with some embodiments of the invention that they may allow for an improved data entering mechanism that can be utilized in electronic devices where it may be important or even necessary to avoid multi-tap technique on the electronic device e.g. for preventing injuries. It is another advantage with some embodiments of the invention that they may allow for an input device that can be operated faster to perform the data entering operation. Still another advantage with some embodiments of the invention is that they may be more efficient in data entering.

### BRIEF DESCRIPTION OF THE DRAWINGS

Further objects, features and advantages of the present invention will become apparent from the following detailed description of the invention, wherein embodiments of the invention will be described in more detail with reference to the accompanying drawings, in which:

FIG. 1 illustrates a portable device that includes a touch sensitive keypad according to an embodiment of the present invention;

FIG. 2A-2F illustrates a way of data entering according to an embodiment of the present invention;

FIG. 3A-3F illustrates a display that might appear on a mobile telephone according to an embodiment of the present invention;

FIG. 4A-4D illustrates a way of data entering according to an embodiment of the present invention;

FIG. 5A-5C illustrates a way of data entering according to an embodiment of the present invention.

### DETAILED DESCRIPTION

Embodiments of the present invention relate, in general, to the field of electronic devices including one or several keypads for entering data to the electronic device. A preferred embodiment relates to a portable communication device including one or more keypads, such as a mobile telephone phone or terminal. However, it should be appreciated that the invention is as such equally applicable to electronic devices such as a Personal Communication System terminal in the form of a Smartphone that may combine a cellular radiotelephone with data processing, facsimile and data communications capabilities; a personal digital assistant (PDA) or a Pocket PC that can include a radiotelephone, pager, Internet/Intranet access, Web browser, organizer and/or calendar; and a conventional laptop and/or palmtop receiver or other appliance that includes a radio-telephone transceiver. It should also be appreciated that the invention is as such equally applicable to electronic devices which do not include any radio communication capabilities. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

Embodiments of the present invention provide for touch-sensitive keypads on a portable device. Contacting, but not pressing, a touch-sensitive keypad creates an input to the portable device. Pressing a key on touch-sensitive keypad causes the same response that would occur with the press of a key on a traditional keypad, such as key pad with buttons to be pushed. That is, in addition to the traditional “neutral” and “pressed” states available for a key or button on a traditional keypad, an intermediate state, which can be referred to as the “touched” state, is available for a key in a touch sensitive keypad. A device may exhibit one type of behaviour when a key is in the “touched” state and another type of behaviour when that key is in the “pressed” state.

The publication “PreSense”: Interaction techniques for finger sensing input devices” by Jun Rekimoto et al at ACM Symposium on User Interface Software and Technology (UIST 2003), pp. 203-212, 2003 discloses an input device for mobile devices, called PreSense keypad. This keypad that is enhanced by touch sensors based on capacitive sensing. This sensor and key combination makes it possible to recognize “which button is about to be pressed”, and the system can provide appropriate information to users. This is called “a preview able user interface” because the users can see the effect of the command in advance. The user can check the corresponding symbols, such as characters, letters, digits or command signs, on the display before typing it. Even if the keys are not large enough to print the symbols on, the screen preview information can assist the users to confirm the entered symbols. This feature can also support multiple function keypads, that is the keypad functions may be changed according to desired operation mode, such as text input mode or universal remote control, or symbols, such as Arabic characters, and digits or Asian characters and digits.

Embodiments of the present invention provide for a touch-sensitive keypad with keys on a mobile phone using the PreSense technology.

The keypad may be a traditional keypad 12 with touch-sensitive buttons or keys 13, where the buttons comprise a touch-sensitive layer 15, such as PreSense. Additionally, the keypad may be a touch-sensitive keypad 12, i.e. a touch-sensitive screen, including virtual keys 13, which are visualized as pattern on the keypad screen 12. The shape of the key may be in any shape, such as circular, square-shape, cylindrical among others.

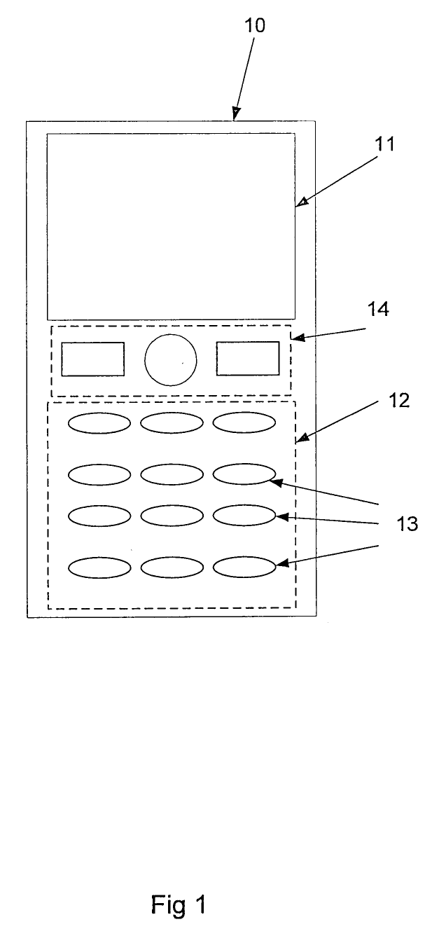

FIG. 1 shows a mobile phone 10, containing a keypad 12 with several keys 13. A software module (not shown) in the mobile phone receives one type of input when a key 13 is touched and another type of input when a pressure is applied on the key. The software module can then cause one type of behaviour in the phone when a touch is detected and another type of behaviour when a pressure is detected. The software module comprises software based instructions, firmware instructions and some system for executing received inputs. The software module may be based on the PreSense technology. Further, the phone also contains a display 11.

The mobile phone 10 according to the invention may also comprise a control keypad 14, a battery, an antenna, a radio unit, a loudspeaker, a microphone, and a camera, not shown, but this is known technology and will not be explained in further detail. All of these components may of course be located at any other suitable position in relation to each other but these relative positioning in the mobile phone is of no importance for the invention and will not be explained any further.

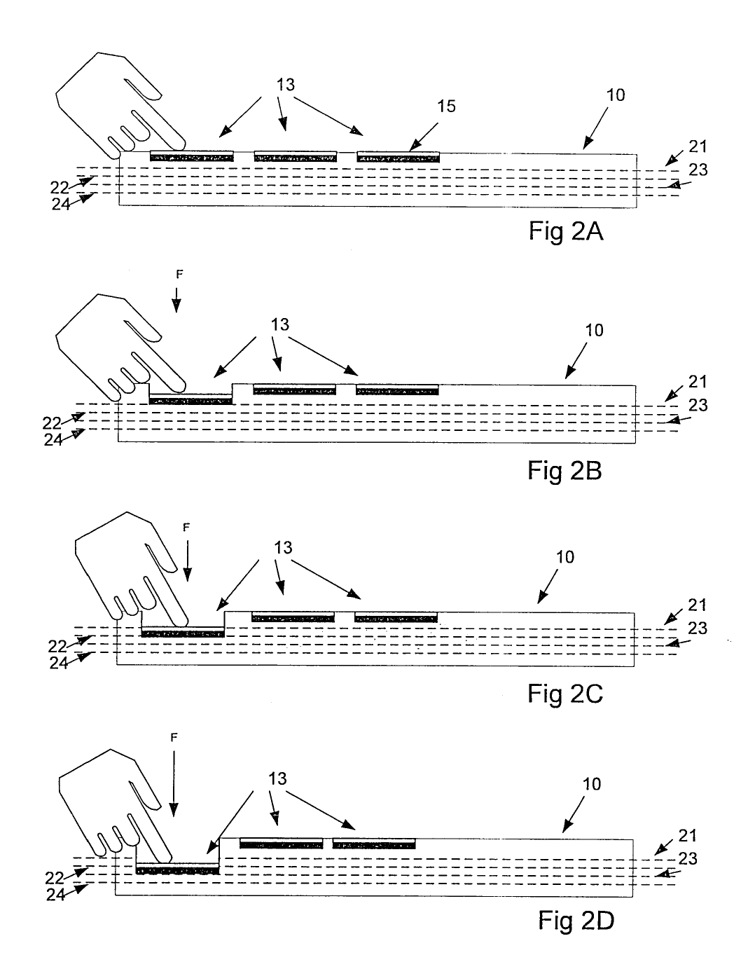

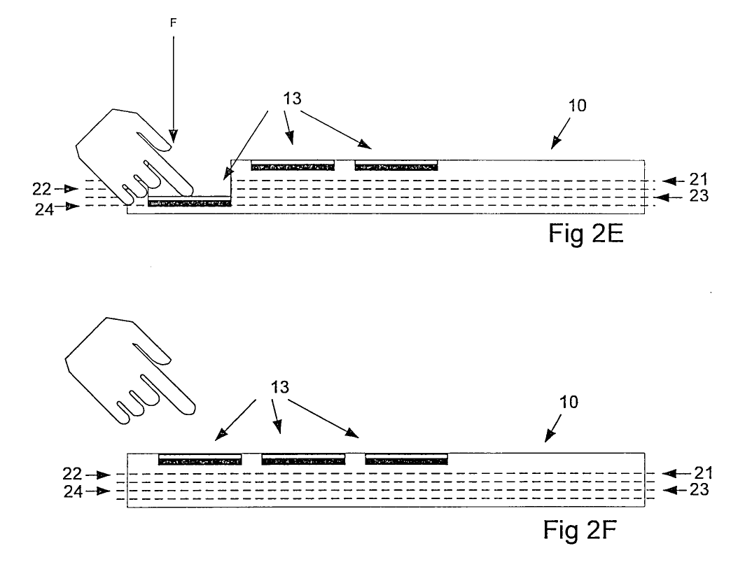

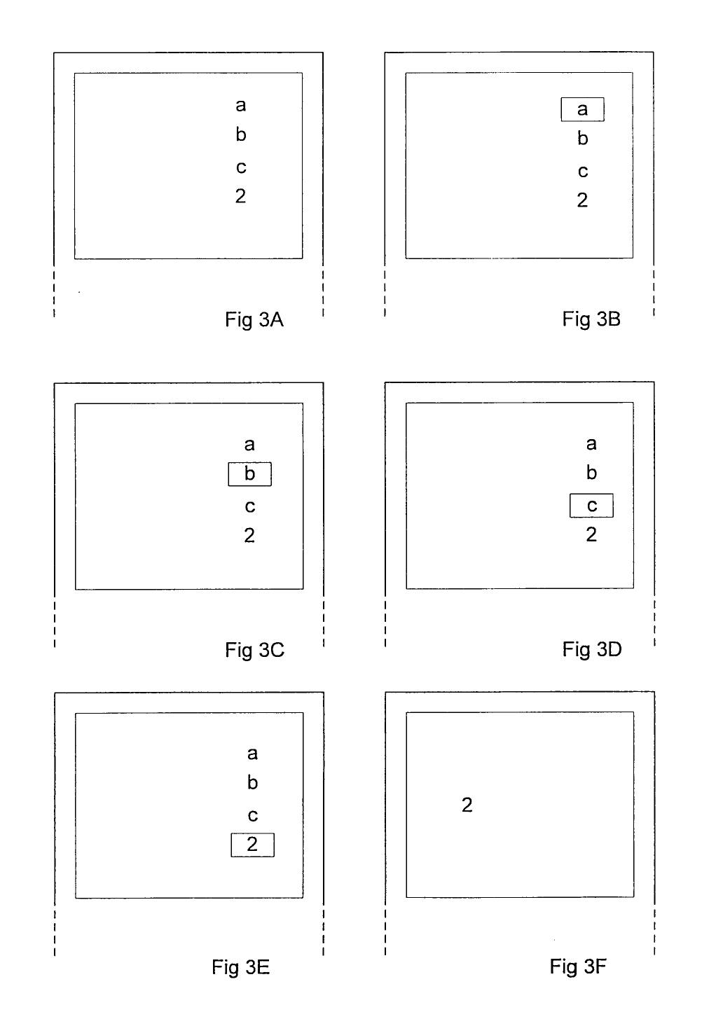

In one embodiment, the mobile phone is in a text entering mode and the keypad includes touch-sensitive buttons to be pushed. The buttons are enhanced with a touch sensitive layer 15, using the PreSense technology. When a user touches one of the keys 13, all of the symbols that can be entered by pressing that key 13 are presented on the display 11 to be previewed by the user. For example, as illustrated in FIGS. 2A and 3A, if the user touches the “2” key, the characters “a”, “b”, “c” and “2” might appear on the display 11. The user can easily see which symbols can by entered if the touched key 13 is pressed and can easily conclude how hard to press the key to enter a desired character. If the user pushes the key 13 with different levels of force F, illustrated by the arrow, different symbols, dependent on the force level, will be highlighted or otherwise emphasized to indicate which symbol will be entered upon completion. The completion of data entry for a particular key is indicated by the removal of contact from the key or by the expiration of a time-out period. The time-out period may be different time intervals dependent on which symbol to be chosen.

This will is shown by using an example, illustrated in FIGS. 2A-2F and 3A-3F. The user touches the “2” key and “a”, “b”, “c” and “2” appears on the display, as shown in FIGS. 2A and 3A. If the user pushes the key 13 downwards to a first level 21, as shown in FIG. 2B, with a gentle pressure, shown by the arrow F, the “a” will be marked, as shown in FIG. 3B. If the user pushes the key a bit harder, as shown in FIG. 2C, into a second level 22, the “b” will be marked, as shown in FIG. 3C. Further, if the user pushes the key a bit harder, as shown in FIG. 2D, into a third level 23, the “c” will be marked, as shown in FIG. 3D. Even further, if the user pushes the key even harder, as shown in FIG. 2E, into the fourth level 24, the “2” will be marked, as shown in FIG. 3E. FIGS. 2F and 3F illustrates that the symbol “2” will be entered if the user removes the contact with the key at the fourth level 24.

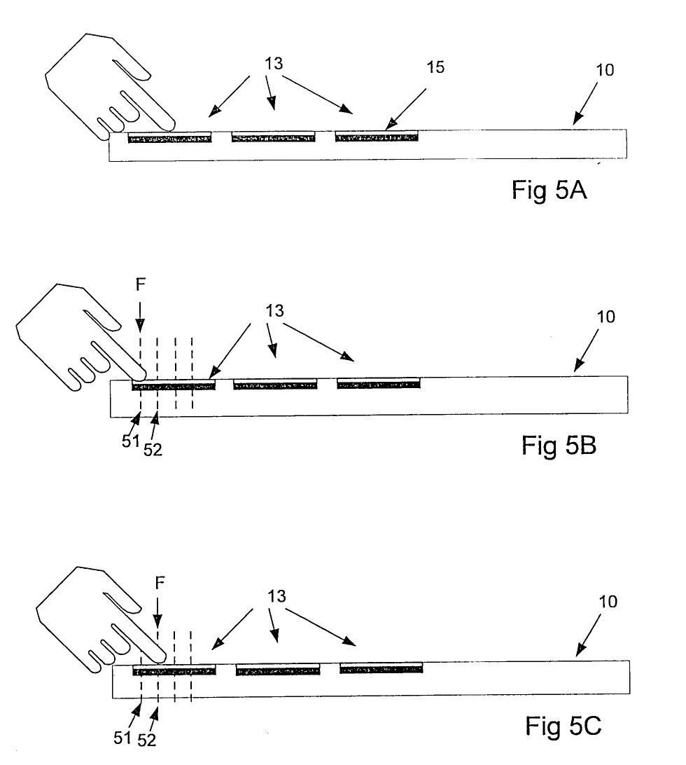

In another embodiment the mobile phone is in a text entering mode and the keypad is a touch sensitive keypad, enhanced with a touch sensor layer 15, using the PreSense technology, including virtual keys visualized on the keypad. When a user touches a one of the keys 13, all of the symbols that can be entered by pressing that key 13 are presented on the display 11 to be previewed by the user. For example, as illustrated in FIGS. 5A and 3A, if the user touches the “2” key, the characters “a”, “b”, “c” and “2” might appear on the display 11. The user can easily see which symbols can by entered if the touched key 13 is pressed and can easily conclude how hard to press the key to enter a desired character. If the user pushes the key 13 with different levels of force F, illustrated by the arrow, different symbols, dependent on the force level, will be highlighted or otherwise emphasized to indicate which symbol will be entered upon completion. The completion of data entry for a particular key is indicated by the removal of contact from the key or by the expiration of a time-out period. The time-out period may be different time intervals dependent on which symbol to be chosen.

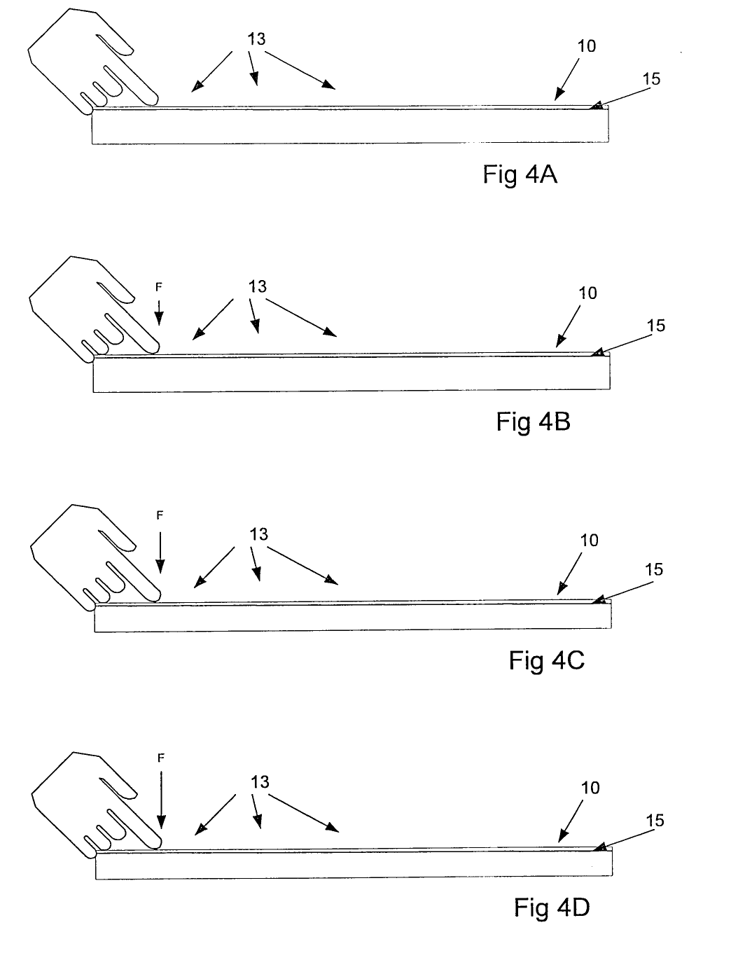

This will is shown by using an example, illustrated in FIG. 4A-4D together with FIG. 3A-3D. The user touches the “2” key and “a”, “b”, “c” and “2” appears on the display, as shown in FIGS. 4A and 3A. If the user pushes the key 13 downwards into a first level, as shown in FIG. 4B, with a gentle pressure, shown by the arrow F, the “a” will be marked, as shown in FIG. 3B. If the user pushes the key a bit harder, illustrated by the arrow F in FIG. 4C, into a second level, the “b” will be marked, as shown in FIG. 3C. Further, if the user pushes the key a bit harder, illustrated by the arrow F in FIG. 4D, into a third level 23, the “c” will be marked, as shown in FIG. 3D. Even further, if the user pushes the key even harder, not shown, into a fourth level, the “2” will be marked, as shown in FIG. 3E.

In another embodiment of the invention, a pressure on the key will be applied sideways to change levels. That is if the user pushes the key 13 sideways to a first level 51, as shown in FIG. 5B, the “a” will be marked, as shown in FIG. 3B. If the user pushes the key a bit further sideways, as shown in FIG. 5C, to the second level 52, the “b” will be marked, as shown in FIG. 3C and so on. The pressure applied may be the same at all levels.

In yet another embodiment of the invention, a pressure applied downwards on the key will remain the same but the different levels will be entered dependent on a time interval. That is, if the pressure on the key is remained for a first predetermined time interval, e.g. 1 s, the first symbol of the key is marked, e.g. “a”, if the pressure on the key remains for a second predetermined time interval, e.g. 2 s, the second symbol “b” will be marked and so on. Thus the present invention introduces a different way of entering symbols on a portable electronic device. The concept addresses issues of efficiency and ergonomics in known Multitap interactions. Entering text becomes faster since the user do not have to lift/release the finger from a key in order to type the characters ‘e’, ‘f’, ‘g’, etc. Instead the user presses soft to type “d”, a bit harder to write an “e”, and even harder to type an “f”.

Initially, the user will look at input feedback on the display in order to learn how hard to press, but will gradually learn how hard to push to write a certain character.

In another embodiment of the invention the use of audio feedback is used as support to the user when the user entering texts on a mobile phone. This could be especially important if the user is unable to see.

In another embodiment of the invention the use of tactile (vibrator) feedback is also possible to support the user in learning how hard to press. The tactile feedback may also be combined with audio feedback.

As compared to known prior art data entry into a mobile phone, which normally uses a multi-tap technique, the present implementation may allow for a faster and more ergonomic solution. This is because less thumb or finger movements, faster and less operations are needed for writing a certain symbol. If tactile and/or audio feedback is available, the user may not have to watch the input screen when performing the data inputs.

Moreover, compared to the prior art solution of data entry into a mobile phone which normally uses T9-technique, the present implementation may allow for more flexibility than the predictive input technology like T9.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A portable electronic device, comprising
a touch sensitive keypad including a plurality of keys;
at least one of said keys is overlaid with multiple input options;
a display where said multiple input options is presented when one of said keys senses an object's presence on said key;
wherein each input option is a symbol;
each input option is associated with a specific level; and
said device further comprising means for detecting said specific level.

2. The portable electronic device according to claim 2, wherein each specific level is entered stepwise in dependence of said input option.

3. The portable electronic device according to claim 1, wherein said specific level is defined by a predetermined pressure applied on said key.

4. The portable electronic device according to claim 2, wherein said pressure is applied downwards.

5. The portable electronic device according to claim 2, wherein said pressure is applied sideways.

6. The portable electronic device according to claim 1, wherein each level is defined by a predetermined time interval during which said object is present on said key.

7. The portable electronic device according to claim 1, wherein said symbol is a character.

8. The portable electronic device according to claim 1, wherein said symbol is a letter.

9. The portable electronic device according to claim 1, wherein said symbol is a digit.

10. The portable electronic device according to claim 1, wherein said input option is confirmed by releasing the contact on said key.

11. The portable electronic device according to claim 1, wherein said keys is overlaid by four input options, where each option is associated by a character, letter or digit.

12. The portable electronic device according to claim 1, wherein each input option is presented by a specific sound.

13. The portable electronic device according to claim 1, wherein each input option is presented by a tactile feedback.

14. The portable electronic device according to claim 1, wherein each input option is presented by a specific sound and tactile feedback.

15. A method for entering inputs on an portable electronic device, comprising a keypad including a plurality of keys, where at least one of said keys is overlaid with multiple input options, said method comprising the steps of:
associating each input option with a level and a symbol;
presenting said multiple input options of said key when detecting an objects presence on said key;
selecting an input option by changing levels.

16. The method according to claim 15, further comprising the steps of entering each specific level stepwise in dependence of said input option.

17. The method according to claim 15, further comprising the step of defining each level by a predetermined pressure;
applying said predetermined pressure on said key.

18. The method according to claim 15, further comprising the step of defining each level by a predetermined time limit and holding said object on said key said predetermined time limit.

19. The method according to claim 15, wherein said symbol is a character.

20. The method according to claim 15, further comprising the steps of confirming said input option by releasing said contact on said key.

21. The method according to claim 15, wherein said keys is overlaid by four input options and each option is associated by a character.

22. The method according to claim 15, further comprising the step of marking said selected input option.

23. The method according to claim 22, further comprising the steps of marking each input option by a specific sound.

24. The method according to claim 22, further comprising the steps of marking each input option by a tactile feedback.

25. The method according to claim 22, further comprising the steps of marking each input option by a specific sound and a tactile feedback.
